(19) United States
(12) Patent Application Publication
(10) Pub. No.: US 2008/0314980 A1
(43) Pub. Date: Dec. 25, 2008

(54) Storage Rack with Automatic Tag Reading Device and Information Processing System Comprising Such a Storage Rack

(75) Inventors: Georges Folcke, Paris (FR); Eric Gout, Igny (FR); Christophe Raoult, Guyancourt (FR)

Correspondence Address: OSLER, HOSKIN & HARCOURT LLP (PROXiP), 1000 DE LA GAUCHETIERE STREET WEST, SUITE 2100, MONTREAL, QC, H3B-4W5, CA

(73) Assignees: MEDITRACE SAS, Verrières-le-Buisson (FR); WINSTEAD ASSETS LIMITED, ROAD TOWN (VG)

(21) Appl. No.: 12/064,458

(22) PCT Filed: Aug. 22, 2006
(86) PCT No.: PCT/FR2006/001966

§ 371 Date: Sep. 2, 2008

(30) Foreign Application Priority Data
Aug. 23, 2005 (FR) 0508697
Aug. 23, 2005 (FR) 0508698
Aug. 23, 2005 (FR) 0508700

(51) Int. Cl. G06Q 90/00

(52) U.S. Cl. 235/385

(57) ABSTRACT

The rack (100) comprises:
on at least one wall (105), at least one antenna (110) comprising at least two coplanar loops through at least one of which current flows in the clockwise direction and, simultaneously, through at least one other loop, the current flows in the anticlockwise direction,
a signal generation circuit (115) to generate signals transmitted by each said antenna, to generate an electromagnetic field, and
a circuit (115) for reception of signals modulating said magnetic field.

Preferably, the rack comprises products equipped with electronic tags and paper labels, said electronic tags positioned on one side of the product opposite another side of the product bearing a paper label.

Preferably, the rack comprises at least one opening, the circuit for generation of signals transmitted by the antennae being slaved to closure of said opening to read the electronic tags after at least one time interval predetermined according to the time of said closure.

This invention relates to a storage rack with automatic tag reading device and an information processing system comprising such a storage rack. It applies, in particular, to the storage of hospital supplies, medical products and medications and to the replenishment of the stocks concerned.

A device to store and identify articles equipped with a bar code described in document U.S. Pat. No. 4,636,634 is known. The bar codes provide an indication of the identity of the articles with which they are associated. This device comprises at least one container adapted to receive an article equipped with a code and, in each container, presence detection means to detect the presence of an article in a container, bar code reading means and circuits connected to the presence detection means and to the reading means to provide an indication of the presence and identity of articles in the containers.

The manufacture of this device is complex since each container must be equipped with two means, firstly to detect the presence of an article and secondly, if an article is present, to read its code. In addition, this device is unreliable since incorrectly positioning the code in the container is sufficient to prevent the code from being read.

This invention aims to overcome these disadvantages.

This invention therefore relates, according to a first aspect, to a rack, characterized in that it comprises:
on at least one wall, at least one antenna comprising at least two coplanar loops through at least one of which current flows in the clockwise direction and, simultaneously, through at least one other loop, the current flows in the anticlockwise direction,
a signal generation circuit to generate signals transmitted by each said antenna, to generate an electromagnetic field, and
a circuit for reception of signals modulating said magnetic field.

Thanks to these arrangements, electronic tags within a highly elongated volume with respect to the plane of said loops can be read.

According to special characteristics, at least one said antenna comprises two loops.

According to special characteristics, at least one said antenna comprises three loops.

According to special characteristics, at least one said antenna comprises four loops.

According to special characteristics, at least one wall containing at least one of the antennae forms the back of the rack.

According to special characteristics, at least one wall containing at least one of the antennae forms a side wall of the rack.

According to special characteristics, at least one wall containing at least one of the antennae forms a central wall of the rack.

According to special characteristics, the signal generation circuit is adapted to successively generate signals for various sets of antennae.

Thanks to these arrangements, antennae oriented along different axes, possibly orthogonal to one another, can be read successively.

According to special characteristics, said rack comprises products equipped with electronic tags and paper labels, said electronic tags positioned on one side of the product opposite another side of the product bearing a paper label.

Thanks to these arrangements, the user is encouraged to position the product so that the electronic tag is opposite and near the back of the rack, the back of the rack then being equipped with an antenna.

According to special characteristics, the rack as outlined above comprises at least one opening, the circuit for generation of signals emitted by the antennae being slaved to closure of said opening to read the electronic tags after at least one time interval predetermined according to the time of said closure.

For example, this predetermined duration is a few seconds. Thanks to these arrangements, the time during which an electromagnetic field is emitted is reduced while keeping up to date an inventory of the products stored in the rack. By choosing a duration of more than ten seconds, there is less risk of reading an electronic tag associated with a product which has just been removed from the rack and which could have been read due to the fact that it was near the rack at the time of closure.

According to special characteristics, said rack comprises a user identification card reader.

Thanks to these arrangements, each product removed from the rack can be associated with the identity of the person removing it, a patient, a procedure, an operating theatre or a doctor, for example.

According to special characteristics, said rack comprises an electrically-controlled lock and means to control said lock adapted to control the unlocking of said lock when the user identification card reader has identified a user.

According to special characteristics, the rack as outlined above comprises warning means adapted to trigger a warning when a minimum number of products of a particular reference has been reached in said rack.

According to special characteristics, the rack as outlined above comprises warning means adapted to trigger a warning on approaching the use-by-date of a product present in said rack.

Thanks to these arrangements, product procurement is made more secure.

According to a second aspect, this invention relates to a information processing system, characterized in that it comprises:
in at least one product user center, at least one rack as outlined above, containing products from at least one supplier;
a server having a database containing information about the products contained in at least one said rack, this database being associated with at least one microprocessor unit and with means of communicating with said rack;
a device located in each product user center including a microprocessor unit associated with means of communicating with said server;
a device located on the premises of each supplier including a microprocessor unit associated with means of communicating with said server;
said server comprising means of selective access to the database, adapted to allow each product user center to have access to all its own stock of products contained in said racks, irrespective of the product suppliers, and to allow each supplier to access, for all product user centers, the stock level, in said racks, of its own products.

Thanks to these arrangements, each product user center can find, in real time, the level and location of its stocks, each supplier can program the future productions and deliveries and the confidentiality of each party's data is guaranteed.

According to special characteristics, the server comprises a computer program adapted to trigger warnings when a minimum number of products of a particular reference has been reached in the stock of a product user center.

According to special characteristics, the server comprises a computer program adapted to produce a sales report for each supplier providing a summary of references by product user center and/or by territory.

Thanks to each of these arrangements, stock management is simplified and efficient both for the product user centers and the suppliers of these product user centers.

Since the advantages, aims and special features of this information processing system are identical to those of the rack outlined above, they are not described here.

With the same objects as the first two aspects described above, this invention relates, according to a third aspect, to a rack comprising:
means to read electronic tags implementing at least one antenna generating, under the control of electronic circuits, a magnetic field;
means to access the content of said rack and
sensor detecting closure of said access means, connected to said electronic circuits, said electronic circuits being adapted, after each detection of a closure of the access means, to control the reading of electronic tags at times determined according to the time of closure of the access means.

Thanks to these arrangements, the time during which an electromagnetic field is emitted is reduced while keeping up to date an inventory of the products stored in the rack. By choosing a duration of more than ten seconds, there is less risk of reading an electronic tag associated with a product which has just been removed from the rack and which could have been read due to the fact that it was near the rack at the time of closure.

According to special characteristics, the electronic circuits are adapted, after each detection of a closure of the access means, to control the reading of electronic tags after a time interval predetermined according to the time of closure of the access means.

Thanks to these arrangements, there is less risk of reading an electronic tag associated with a product which has just been removed from the rack and which is near the rack at the time of closure of the access means.

According to special characteristics, the electronic circuits are adapted, after each detection of a closure of the access means, to control the reading of electronic tags immediately after the time of closure of the access means.

According to special characteristics, the reading means comprise a plurality of antennae and electronic signal generation circuits adapted to successively control the generation of electromagnetic fields by different sets of antennae.

Thanks to these arrangements, antennae oriented along different axes, possibly orthogonal to one another, can be read successively.

According to special characteristics, the rack as outlined above comprises a user identification card reader.

Thanks to these arrangements, each product removed from the rack can be associated with the identity of the person removing it, a patient, a procedure, an operating theatre or a doctor, for example.

According to special characteristics, the rack as outlined above comprises an electrically-controlled lock and means to control said lock adapted to control the unlocking of said lock when the user identification card reader has identified a user.

According to a fourth aspect, this invention relates to a information processing system comprising:
at least one product user center, at least one rack as outlined above, containing products from at least one supplier;
a server having a database containing information about the products contained in at least one said rack, this database being associated with at least one microprocessor unit and with means of communicating with said rack;
a device located in each product user center including a microprocessor unit associated with means of communicating with said server;
a device located on the premises of each supplier including a microprocessor unit associated with means of communicating with said server;
said server comprising means of selective access to the database, adapted to allow each product user center to have access to all its own stock of products contained in said racks, irrespective of the product suppliers, and to allow each supplier to access, for all product user centers, the stock level, in said racks, of its own products.

Thanks to these arrangements, each product user center can find, in real time, the level and location of its stocks, each supplier can program the future productions and deliveries and the confidentiality of each party's data is guaranteed.

According to special characteristics, the server comprises a computer program adapted to trigger warnings when a minimum number of products of a particular reference has been reached in the stock of a product user center.

According to special characteristics, the server comprises a computer program adapted to produce a sales report for each supplier providing a summary of references by product user center and/or by territory.

Thanks to each of these arrangements, stock management is simplified and efficient both for the product user centers and the suppliers of these product user centers.

Since the other advantages, aims and special features of this information processing system, subject of the fourth aspect of this invention are similar to those of the rack subject of the third aspect of this invention, as outlined above, they are not described here.

Furthermore, the use of electronic tags, such as RFID (RadioFrequency IDentification) tags poses numerous problems when they are in the presence of metallic parts, such as metallic cans used for the storage of objects, liquids or food. The electromagnetic field used to read these electronic tags is in fact disturbed by the metallic parts, impairing, if not preventing, communication with the electronic tag.

This invention also aims to overcome these disadvantages.

Thus, this invention relates, according to a fifth aspect, to a product comprising at least one metallic part with at least one narrow edge, characterized in that it comprises an electronic tag with one antenna positioned substantially perpendicular to a narrow edge of said metallic part.

The inventors have in fact discovered that, with these characteristics, the electronic tag could be read despite the proximity of the metallic part and the electronic tag.

According to special characteristics, the electronic tag antenna has a width, measured in the direction of the thickness of the metallic part, greater than the thickness of the edge of the metallic part opposite which the antenna is positioned.

According to special characteristics, the product as outlined above has the shape of a rectangular parallelepiped and comprises said electronic tag on one of its four smallest sides.

According to special characteristics, the product as outlined above has the shape of a rectangular parallelepiped and comprises a paper label positioned on one side of the product opposite to a side of the product bearing said electronic tag.

According to special characteristics, the product as outlined above has the shape of a rectangular parallelepiped and comprises a paper label positioned on one side of the product adjacent to a side of the product bearing said electronic tag on one of its small sides.

Thanks to each of these arrangements, when the product is stored, in a stack or vertically in a cabinet, the user is encouraged to position it so that its paper label is visible. Due to this position, the electronic tag is positioned toward an antenna positioned so as to read the electronic tags.

According to a sixth aspect, this invention relates to a rack which comprises walls, means to read electronic tags comprising at least one antenna in at least one of the walls of said rack and shelves supporting products as outlined above.

According to special characteristics, the reading means comprise a plurality of antennae and electronic signal generation circuits adapted to successively control the generation of electromagnetic fields by different sets of antennae.

Thanks to these arrangements, antennae oriented along different axes, possibly orthogonal to one another, can be read successively.

Since the other advantages, aims and special features of this rack, subject of the sixth aspect of this invention are similar to those of the product subject of the fifth aspect of this invention, as outlined above, they are not described here.

The various aspects of this invention, their main characteristics and their special characteristics are intended to be combined to form an efficient product identification system.

Other advantages, aims and features of this invention will appear on reading the following description, given for a non-limiting explanatory purpose and referring to the attached drawings in which:

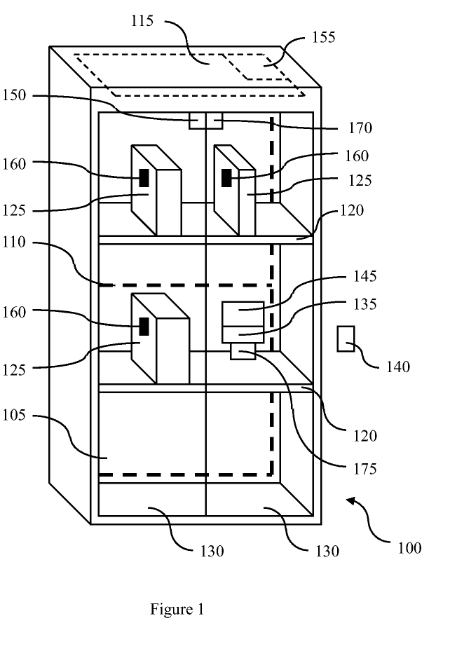

FIG. 1 is a diagrammatic representation of a first mode of realization of a rack according to this invention;

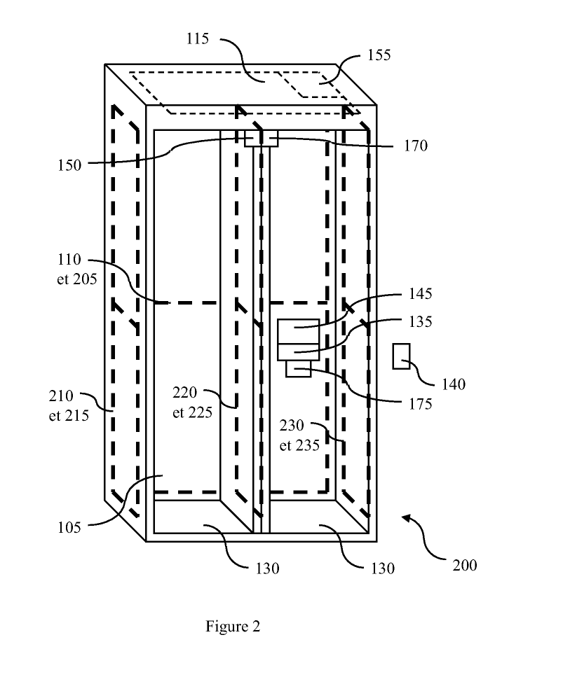

FIG. 2 is a diagrammatic representation of a second mode of realization of a rack according to this invention;

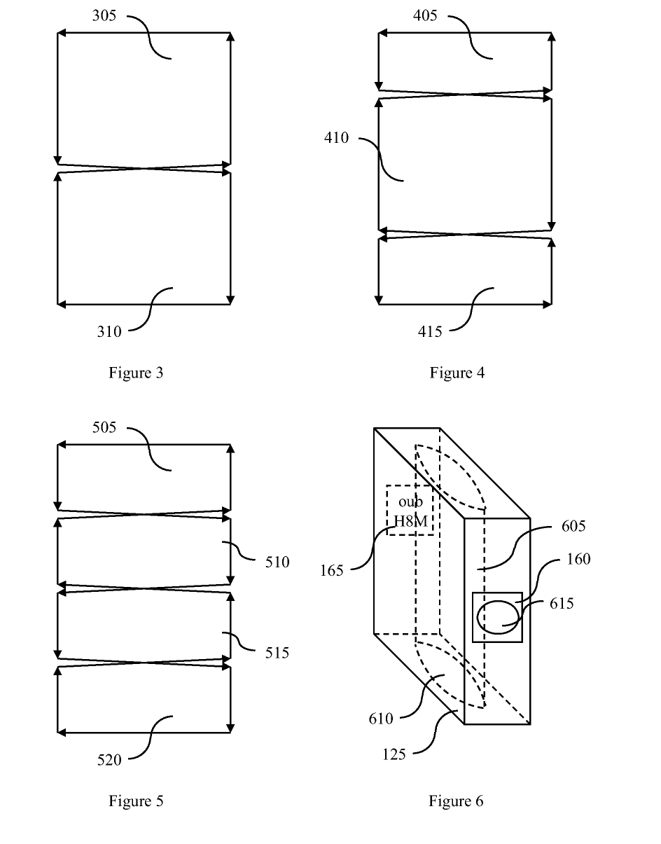

FIG. 3 is a diagrammatic representation of a first shape of antenna incorporated in a rack illustrated in FIG. 1 or 2;

FIG. 4 is a diagrammatic representation of a second shape of antenna incorporated in a rack illustrated in FIG. 1 or 2;

FIG. 5 is a diagrammatic representation of a third shape of antenna incorporated in a rack illustrated in FIG. 1 or 2;

FIG. 6 represents a product especially adapted to be stored in a rack as illustrated in FIG. 1;

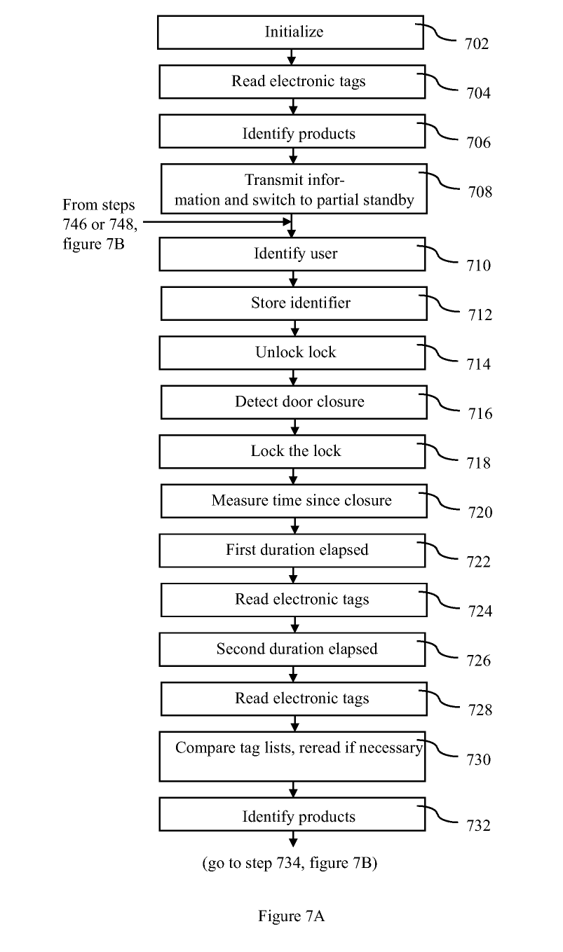

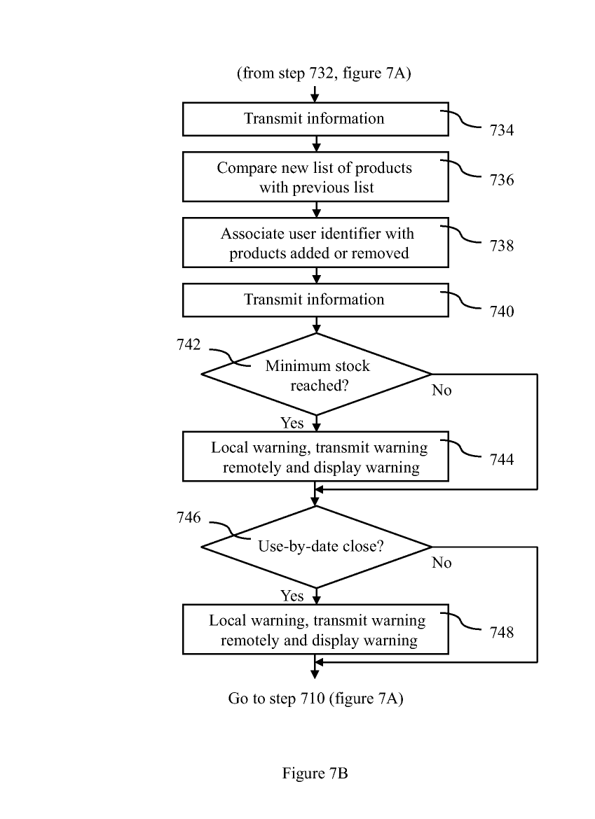

FIG. 7 represents, as a logic diagram, the operation of a rack as illustrated in FIG. 1 or 2;

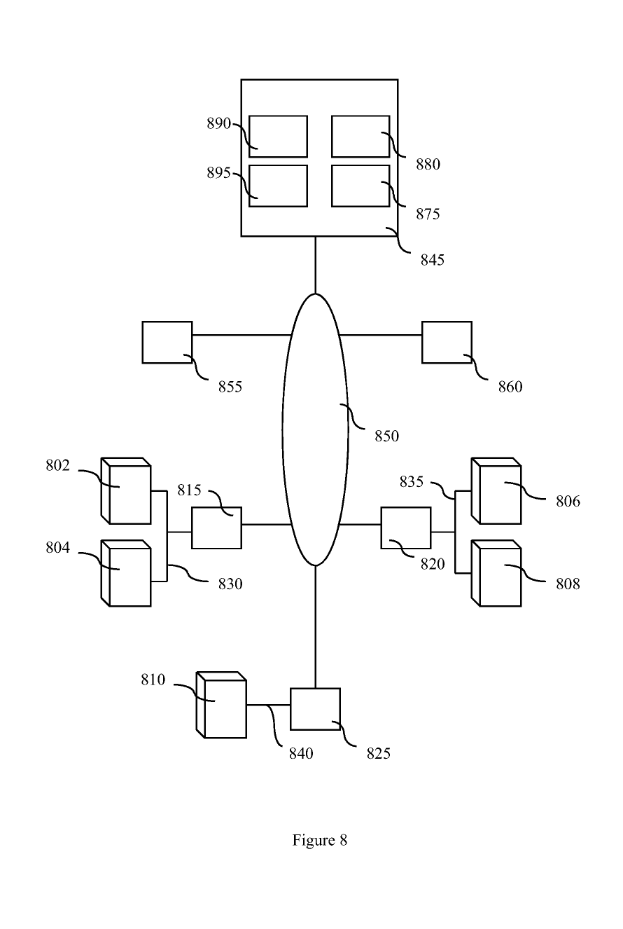

FIG. 8 represents a information processing system according to this invention and comprising a plurality of racks as illustrated in FIG. 1 or 2 and

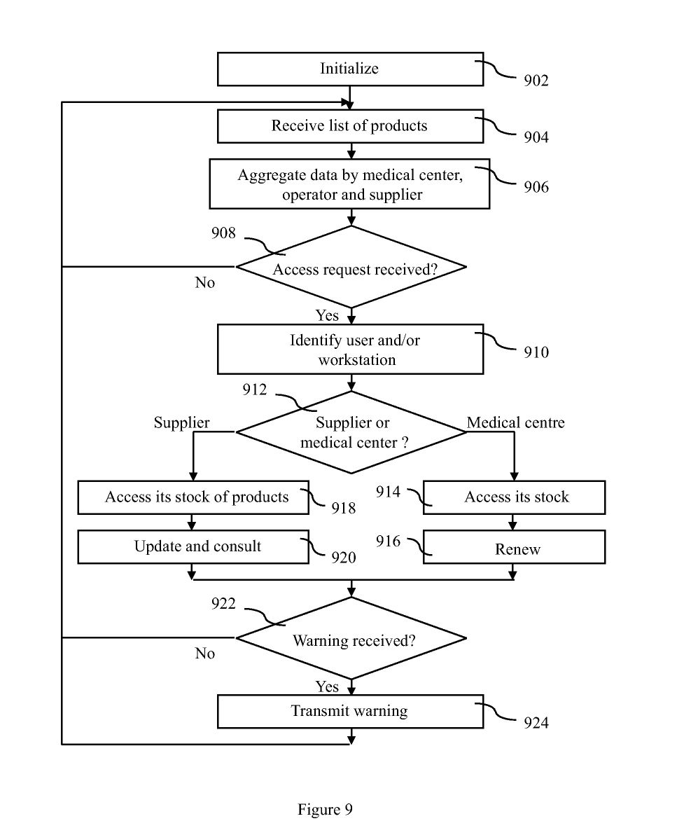

FIG. 9 represents a flowchart showing the operation of the information processing system illustrated in FIG. 8.

FIG. 1 shows a rack 100 comprising, in or on its back wall 105, an antenna 110, in its upper part, electronic circuits 115, shelves 120 supporting products 125 equipped with electronic tags 160, an electric lock 150, a communication means 155, two doors 130 of which one supports a reader 135 to read an identification card 140 and a display 145, a door closure sensor 170 and an emergency opening button 175.

The rack 100, the shelves 120 and the doors 130 are made from rigid materials, for example wood, glass or plastic.

The antenna 110 is connected to the back wall 105, for example by gluing, stapling or inclusion. The antenna 110 has one of the antenna shapes illustrated in FIGS. 3 to 5.

The electronic tags 160 and the electronic circuits 115 are of type known in the field of radio frequency identification (RFID). They comprise, in a known manner, a signal generation circuit adapted to successively generate signals for each antenna or set of antennae incorporated in the rack (see also FIG. 2) and a circuit for reception of signals modulating said magnetic field.

The electronic circuits 115 consist, for example, of a computer and circuits specific to the field of RFID electronic tags. They are adapted to supply to the antenna 110, at times predetermined according to the closure of the doors 130, a signal enabling it to generate an electromagnetic field. This electromagnetic field is used to power the electronic tags 160 and transmit messages, requests or instructions to the tags 160. The electronic circuits 115 are also adapted to detect the signals transmitted by the electronic tags 160, by modulation of the magnetic field transmitted by the antenna 110, to process these signals, to identify the electronic tags and to transmit these identifiers to the communication means 155.

The electronic circuits 115 are also adapted to process the signals from the card 140 reader 135 to identify a user and, to control the operation of the electric lock 50, detect the closure of the doors via the sensor 170 and control the contents of the display 145.

The electronic circuits 115 are also adapted to unlock the electric lock 150 when the emergency opening button 175 is pressed.

The operation of the electronic circuits 115 is detailed with reference to FIG. 7.

The electric lock 150 is of known type. It is used to lock the doors 130. The communication means 155 allows remote communication with a computer, a server or a information processing system comprising a network, according to known techniques, on wired or wireless support. The communication means 155 is, for example, a modem.

The identification card 135 reader 140 is, for example, of type known in the field of radio frequency identification. In this case, each card 140 comprises a transponder, or electronic tag and the reader 135 comprises an antenna for transmission and reception of magnetic fields modulated for the data exchanges required to identify the cards 140.

As a variant, the reader 135 is replaced by a biometric identification device of known type, to identify the users accessing the content of the rack 100.

The display 145 is of known type, for example a Liquid Crystal Display (LCD screen) and used to display visible messages to users, for example instructions for their identification, for the positioning of products 125 in the rack 100 and to display warnings if the number of products of a given reference reaches a predetermined value or if one of the products is approaching its use-by-date.

The door closure sensor 170 is of known type, for example dry contact or Hall effect type. It is preferably incorporated in the electric lock 150.

Preferably, when the back wall supports an antenna, arrangements are made so that the electronic tags cannot be placed in the immediate vicinity of this antenna. For example, the back wall in front of each antenna is made slightly thicker, projecting into the rack.

FIG. 2 shows, in a rack 200, the same elements as in FIG. 1, the shelves and the products not being shown for clarity reasons, as well as an antenna 205, in or on the back wall 105 of the rack 200, and antennae 210, 215, 220, 225, 230 and 235, placed two by two in or on the side walls 240 and 245 and central wall 250 of the rack 200. In this case, the electronic circuits 115 are adapted to multiplex the uses of the antennae to successively query the electronic tags 160 whose antennae are positioned according to orthogonal axes.

FIG. 3 shows that a first shape of antenna 300 incorporated in a rack illustrated in FIG. 1 or 2 consists of a figure-8, i.e. two coplanar loops 305 and 310, the conductor forming this antenna going alternately through one or the other of the two loops, with opposite directions of rotation. In this figure, only one coil has been represented, it being understood that the antenna actually comprises a large number of superimposed coils.

Consequently, when the current flows through the two coplanar loops, in one of the loops it flows in the clockwise direction and, simultaneously, in the other loop it flows in the anticlockwise direction. This configuration generates an electromagnetic field over an extended volume near the back wall 105 of the rack.

FIG. 4 shows that a second shape of antenna 400 incorporated in a rack illustrated in FIG. 1 or 2 consists of three coplanar loops 405, 410 and 415, the conductor forming this antenna going alternately through the three loops, with directions of rotation alternately clockwise and anticlockwise. In this figure, only one coil has been represented, it being understood that the antenna actually comprises a large number of superimposed coils.

Consequently, when the current flows through the three coplanar loops, in at least one of the loops it flows in the clockwise direction and, simultaneously, in at least one other loop it flows in the anticlockwise direction. This configuration generates an electromagnetic field over an extended volume near the back wall 105 of the rack.

FIG. 5 shows that a third shape of antenna 500 incorporated in a rack illustrated in FIG. 1 or 2 consists of four coplanar loops 505, 510, 515 and 520, the conductor forming this antenna going alternately through the four loops, with directions of rotation alternately clockwise and anticlockwise. In this figure, only one coil has been represented, it being understood that the antenna actually comprises a large number of superimposed coils.

Consequently, when the current flows through the four coplanar loops, in two of these loops it flows in the clockwise direction and, simultaneously, in the other two loops it flows in the anticlockwise direction. This configuration generates an electromagnetic field over an extended volume near the back wall 105 of the rack.

In the case of the rack illustrated in FIG. 2, for example, the back wall supports both an antenna as illustrated in FIG. 3 and an antenna as illustrated in FIG. 4 and each side or central wall supports an antenna as illustrated in FIG. 3. The inventors discovered, in fact, that this configuration covered the entire interior volume of the rack 200 without leaving any dead areas, with the electromagnetic fields successively transmitted by the various antennae.

FIG. 6 shows a product 125 comprising a paper label 165 and the electronic tag 160. The product comprises a metallic part 610 (in this case a metallic or metalized bag) which is thin, in other words of thickness less than one quarter of its largest dimension, on at least one of its edges 605. The electronic tag 160 has an antenna 615 which is positioned substantially perpendicular to a thin edge of the metallic part 610.

The antenna 615 preferably has a width, measured in the direction of the thickness of the metallic part 610, greater than the thickness of the edge 605 of the metallic part opposite which the antenna is positioned.

The inventors have discovered that, with these characteristics, the electronic tag could be read despite the proximity of the metallic part and the electronic tag.

In FIG. 6, the product 125 has the shape of a rectangular parallelepiped and comprises the electronic tag on one of its four smallest sides. The product 125 also comprises a paper label 165 positioned on a side of the product opposite the side of the product bearing said electronic tag. In this case, the paper label 165 shows the reference “duo M8H”.

As a variant, the paper label 165 is positioned on one side of the product adjacent to a side of the product bearing said electronic tag 160 on one of its small sides.

Consequently, when the user stores the product 125, in a stack or vertically in the rack 100 or 200, he is encouraged to position it so that its paper label 165 is visible. Due to this position, the electronic tag 160 is positioned towards the back wall of the rack or towards one of its shelves, allowing the electronic tags 165 to be read by an antenna positioned on or in the back wall or a shelf, respectively.

The inventors discovered, in fact, that with this configuration:
the user could read the text shown on the paper label 165, without moving the product 125, when the rack doors 130 are open or through these doors 130 when they are transparent, and
the electronic tags 160 were positioned near to and opposite the antenna supported by the back wall 105 of the rack.

When the product 125 is flat, for example with a thickness of 10 mm to 12 mm, the electronic tag 160 preferably comprises an elongated antenna 615, for example measuring 8 mm×80 mm.

As show in FIG. 7, an initialization step 702 is first carried out, during which associations are defined between:
electronic tag identifiers and product references,
electronic tag identifiers and product use-by-dates,
minimum numbers of products of each reference below which products with this reference must be reordered and
card identifications with user identifications.

This step 702 can be carried out by reading data in a local and/or remote database, as indicated with reference to FIG. 9.

The rack circuits then perform a first read of the electronic tags present in the rack by successively generating magnetic fields on the various sets of antennae incorporated in the rack, step 704, associate them with product references, step 706, transmit this information remotely, step 708, and go into standby while leaving the identification card 140 reader 135 switched on and displaying, on the display, the rack use instructions.

When a user comes to open the rack, he is identified, step 710, his identifier is stored, step 712, and the rack lock is unlocked, step 714.

When the rack door closure sensor indicates that the doors are closed, step 716, the lock is locked, step 718, and the time which has elapsed since the doors were closed is measured, step 720.

When this duration reaches a first predetermined value, for example ten seconds, step 722, the electronic tags of the products present in the rack are read, step 724, by successively using the rack antennas.

When the time which has elapsed since the rack was closed reaches a second predetermined value, for example one minute, step 726, the electronic tags of the products present in the rack are read, step 728, by successively using the rack antennas.

The list of identifiers obtained during steps 724 and 728 are then compared and, if they are different, additional reads of the electronic tag identifiers are carried out, at predetermined time intervals, for example one minute between two reads, until three successive reads give the same list, step 730.

The electronic tag identifiers are then associated with product references, step 732, and this information is transmitted remotely, step 734.

The list of products present is then compared with the list of products previously present, step 736, and the identification of the user who opened the rack is associated with the references and identifiers of the products which have been added to or removed from the rack, step 738, and this information is transmitted remotely, step 740.

During a step 742, a check is then carried out to determine, for one or more product references, whether the number of products present in the rack is less than or equal to a predetermined value. If yes, during a step 744, a local warning is triggered, this information is transmitted remotely and the references of the missing products are shown on the display.

Then, if the result of step 742 is negative or after step 744, during a step 746, a check is carried out to determine whether the use-by-date of at least one product present in the rack lies within a future of predetermined duration, for example one month. If yes, during a step 748, a local warning is triggered, this information is transmitted remotely and the references of the products concerned are shown on the display.

Then, if the result of step 746 is negative or after step 748, the rack circuits go into standby while leaving the identification card 140 reader 135 switched on and displaying, on the display, the rack use instructions, before returning to step 710.

FIG. 8 shows a information processing system 800 comprising a plurality of racks 802 to 810, as illustrated in FIG. 1 or 2 and connected together and to local workstations 815, 820 and 825, by local networks respectively 830, 835 and 840, a server 845 connected to said local networks, by an external network 850 and external workstations 855 and 860 connected, via the external network 850, to the server 845.

The workstations 815, 820, 825, 855 and 860, as well as the server 845 are of known type and each comprises a microprocessor and communication means, for example a modem, enabling them to communicate with the networks to which they are directly connected.

The local workstations implement several user interfaces. A first user interface is used to display the inventory of products present in the various racks of the product user center and, possibly, to launch a read of all the tags on the products present in the rack to check the inventory, for example before a medical operation. This user interface can also be used to access the history of previous inventories.

A second user interface is used to manage automatic renewals and transmit them to the server which forwards them to the suppliers concerned. This restocking can be carried out at fixed times, for example at the end of the working day to avoid renewing a product which is put back in a rack after having been removed, for example in preparation for surgery.

A third user interface is used to assign a complex meaning to an identification card, for example assignment of the products which will be taken from a rack with this card in a specific time interval, to an operating theatre, a patient, a user or a doctor. This assignment allows management of the products consumed during an operation and their invoicing, it being understood that the products put back later into one of the racks, identified by their electronic tags, are recredited to the stock of products.

The external network 850 is, for example, the Internet.

In addition, the server 845 comprises a database 875, means of selective access 880 to the database by the workstations 815, 820, 825, 855 and 860, a warning computer program 890 and a monitoring computer program 895.

The database 875 contains information concerning the products contained in the racks 802 to 810.

The workstations 855 and 860 are implemented by suppliers of products likely to be stored in racks subject of this invention, preferably equipped with paper labels and electronic tags placed on opposite sides of these products.

The workstation 815 and the racks 802 and 804 are located in a first product user center and contain products from suppliers implementing the workstations 855 and 860.

The workstation 820 and the racks 806 and 808 are located in a second product user center and contain products from suppliers implementing the workstations 855 and 860.

The workstation 825 and the rack 810 are located in a third user center and contain products from suppliers implementing the workstations 855 and 860.

The means of selective access 880 to the database are of known type, for example authentication software (for example with user name and password or with card or biometric recognition) or signature software and are adapted to allow each product user center to access its own stock of products contained in the racks 802 to 810, irrespective of the product suppliers.

The means of selective access 880 are also adapted to allow each supplier to access, for all product user centers, the stock level, in the racks 802 to 810, of its own products.

The warning computer program 890 is adapted to trigger warnings when a minimum number of products of a particular reference has been reached in the stock of a product user center. This warning can be used to increase the number of products to be renewed to avoid further warnings.

The monitoring computer program 895 is used to produce a sales report for each supplier, giving a summary of the references by product user center and/or by territory.

Since each workstation of a product user center can be connected by the Internet to the server 845, it can be identified and receive information concerning the products in stock, i.e. entering a rack or leaving a rack in the product user center concerned. Each workstation of a product user center can also consult the delivery delays for the products stored in order to manage their renewal.

As shown on FIG. 9, an initialization step 902 is carried out to initialize the various computer devices, during which the database of the product references and suppliers, and the means of authenticating the users and/or the various workstations likely to access the database, are created.

Then, during a step 904, each rack supplies a first list of products it contains, this list being automatically renewed each time the doors of these racks are closed and completed by warnings and user identifications, as explained previously.

During a step 906, the server aggregates the data received by product user center, by supplier and by user.

During a step 908, the server determines whether a request to access the database has been received. If not, return to step 904. If the result of step 908 is positive, during a step 910, the user and/or the workstation attempting to access the database are identified.

If the identification fails, return to step 904. If the identification succeeds, during a step 912, a check is carried out to determine whether the user and/or the workstation attempting to access the database is a product user center workstation or a supplier workstation.

If it is a product user center, access is allowed to all its own stock of products contained in the racks of this product user center, irrespective of the product suppliers, step 914.

It is also allowed, step 916, to renew products with the suppliers, in which case the renewal request is sent to the suppliers concerned. The product user center therefore selects, in the database, the product references and quantities to renew the stock, the renewal forms being automatically distributed between the suppliers of the references concerned.

If, during step 912, a supplier is found to be accessing, during a step 918, this supplier is allowed to access, simultaneously for all the product user centers, the stock level, in said racks, of its own products.

The supplier is also allowed, step 920, to update its product references, prices and delivery delays and to consult the renewal forms sent to it. The server can therefore be used to produce a sales report for each supplier, giving a summary of the references by product user center and/or by territory, according to known techniques.

After step 916 or 920, a check is carried out to determine whether a warning has been received from a rack, step 922, and, if yes, this warning is transferred to the workstation of the product user center concerned, step 924. Then, if the result of step 922 is negative or after step 924, return to step 904.

As can be seen from the above, the invention is a significant improvement over the existing technique by providing an installation which can be used to manage simply and efficiently the stock of medical equipment in the product user centers and to manage the flow of equipment between the suppliers and these product user centers while allowing the suppliers to manage their stock stored in each product user center. This equipment may be disposable equipment or equipment that can be recycled, in particular equipment used for the fitting of some prostheses.

1-14. (canceled)

15. An information processing system comprising:
in at least one product user center, at least one rack for storing products from at least one supplier; said at least one supplier having a premises; said at least one rack comprising at least one wall, on said at least one wall at least one antenna, a signal generation circuit to generate signals transmitted by said at least one antenna, to generate an electromagnetic field, and a circuit for reception of signals modulating said electromagnetic field:
a server comprising a database containing information about the products contained in said at least one rack, said database being associated with at least one microprocessor unit and with a device for communicating with said at least one rack;
a device located in said at least one product user center comprising a microprocessor unit associated with a device for communicating with said server;
a device located on the premises of said at least one supplier comprising a microprocessor unit associated with a device for communicating with said server; and
said server comprising a module of selective access to said database, adapted to allow said at least one product user center to access stock level of products contained in said at least one racks, irrespective of the product suppliers, and to allow said at least one supplier to access a stock level of products contained in said at least one rack, irrespective of the product user centers.

16. An information processing system according to claim 15, wherein said server comprises a computer program adapted to trigger warnings when a minimum number of products of a particular reference has been reached in the stock level of said at least one product user center.

17. An information processing system according to claim 15 wherein said server comprises a computer program adapted to produce a sales report for said at least one supplier, the sales report providing a summary of references by at least one of product user center and territory.

18. A server for use in an information processing system comprising:
in at least one product user center, at least one rack for storing products from at least one supplier; said at least one supplier having a premises; said at least one rack comprising at least one wall, on said at least one wall at least one antenna, a signal generation circuit to generate signals transmitted by said at least one antenna, to generate an electromagnetic field, and a circuit for reception of signals modulating said electromagnetic field;
a workstation located in said at least one product user center comprising a microprocessor unit associated with a device for communicating with said server;
a workstation located on the premises of said at least one supplier comprising a microprocessor unit associated with a device for communicating with said server;
said server comprising:
a database containing information about the products contained in said at least one rack, said database being associated with at least one microprocessor unit and with a device for communicating with said at least one rack; and
a module of selective access to said database, adapted to allow said at least one product user center to access a stock level of products contained in said at least one rack, irrespective of the product suppliers, and to allow said at least one supplier to access a stock level of products contained in said at least one rack, irrespective of the product user centers.
